(19) United States
(12) Patent Application Publication
(10) Pub. No.: US 2026/0358944 A1
(43) Pub. Date: Nov. 12, 2026

(54) COMPANION PASSENGER CONFIGURATION OF ASSISTED PASSENGER'S ENTERTAINMENT SYSTEM GRAPHICAL USER INTERFACE

(71) Applicant: Thales Avionics, Inc., Irvine, CA (US)

(72) Inventors: Nicolas Besnard, Saint-Médard-en-Jalles (FR); Jueren Ma, Hacienda Heights, CA (US); Celie Navatel, Costa Mesa, CA (US); Rayza Zayerz, Huntington Beach, CA (US)

(21) Appl. No.: 19/545,241

(22) Filed: Feb. 20, 2026

Related U.S. Application Data
(60) Provisional application No. 63/761,290, filed on Feb. 21, 2025.

(51) Int. Cl. G06F 3/04847

(52) U.S. Cl. CPC G06F 3/04847

(57) ABSTRACT

An IFE system including a first VDU, a second VDU, and a GUI control processor. The GUI control processor communicatively connected to the first VDU and second VDU. The first VDU includes a first GUI, and the second VDU includes a second GUI. The GUI control processor is configured to perform operations including receiving input from the companion passenger requesting configuration of the second GUI of the second VDU. The operations include determining whether the companion passenger is granted access privileges to configure the second GUI of the second VDU, and, responsive to granting the access privileges, receiving configuration input from the companion passenger through the first VDU. The operations include generating GUI configuration commands based on the configuration input and transmitting the GUI configuration commands to the second VDU. The second VDU modifies the second GUI of the second VDU based on the received GUI configuration commands.

### CROSS REFERENCE TO RELATED APPLICATIONS

This application is a national stage application claiming priority to U.S. provisional Application No. 63/761,290, filed Feb. 21, 2025, the disclosure and content of all of which are incorporated by reference herein in their entireties.

### TECHNICAL FIELD

Embodiments described herein relate generally to electronic entertainment systems and, more particularly, to graphical user interfaces for controlling entertainment systems.

### BACKGROUND

In-flight entertainment (IFE) systems are deployed onboard aircraft to provide entertainment for passengers (also “users”) in a passenger cabin. IFE systems typically provide passengers with television, movies, games, audio entertainment programming, and other content.

IFE systems typically provide a Graphical User Interface (GUI) through an in-seat Video Display Unit (VDU) that can include a user interactive touch selection interface. The GUI includes graphical elements that can include buttons, text, icons, and images. A user can touch select a displayed graphical element to initiate an action or navigate to another layer of graphical elements associated with the selected graphical element.

Designers invest significant time and effort into producing a GUI that is both intuitive and efficient for a typical passenger to use. Once the layout of graphical elements and the interconnect of graphical elements on different hierarchical layers is selected, the GUI is programmatically implemented to provide a same interface on all VDUs within an aircraft and across all aircraft using that type of VDU.

Passenger satisfaction with a flight experience and, ultimately, with an airline can be significantly impacted by the assumptions made by the designers during the layout and configuration design for the GUI of VDUs for an IFE system.

### SUMMARY

In accordance with various embodiments disclosed herein, an IFE system for an aircraft is provided that includes one or more GUI control processor(s) that allow one passenger (“companion passenger”) to interface through the VDU serving the companion's seat to generate commands that operate to configure operation of the GUI provided through another VDU serving another passenger (“assisted passenger”) to obtain services through the configured VDU. Non-limiting examples of relationships between companion and assisted passengers can include, but are not limited to, crew and passenger(s), adult child and elderly parent, parent and child, caregiver and mentally or visually disabled person, etc.

In some example embodiments, the IFE system includes a first VDU, a second VDU, and a GUI control processor. The first VDU is assigned to a companion passenger, and the second VDU assigned to an assisted passenger. The GUI control processor communicatively connected to the first VDU and the second VDU. The first VDU includes a first GUI of the first VDU for display to the companion passenger. The second VDU includes a second GUI of the second VDU for display to the assisted passenger. The GUI control processor is configured to perform operations including receiving, from the first VDU, input from the companion passenger requesting configuration of the second GUI of the second VDU. The operations also include determining whether the companion passenger is granted access privileges to configure the second GUI of the second VDU. The operations also include, responsive to granting the access privileges, receiving configuration input from the companion passenger through the first VDU. The operations also include generating GUI configuration commands based on the configuration input and transmitting the GUI configuration commands to the second VDU. Additionally, the second VDU is configured to modify the second GUI of the second VDU based on the received GUI configuration commands.

Other IFE systems, and related methods, and computer program products according to embodiments of the inventive subject matter will be or become apparent to one with skill in the art upon review of the following drawings and detailed description. It is intended that all such additional embodiments be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiments of the invention. In the drawings:

FIGS. 1-3 illustrate example GUIs of a VDU in a companion passenger seat which enable the companion passenger to configure the GUI provided to an assisted passenger through another VDU in the seat of the assisted passenger in accordance with some embodiments;

FIG. 4 illustrates an example GUI that has been configured by the companion passenger and has been implemented for use by the assisted passenger through the VDU in the seat of the assisted passenger in accordance with some embodiments;

FIG. 5 illustrates a block diagram of an IFE system which includes one or more GUI control processor(s) which are operative to enable one VDU to configure the GUI provided through another VDU in accordance with some embodiments;

FIG. 6 illustrates example operations performed by the GUI control processor to enable one VDU to configure the GUI provided through another VDU in accordance with some embodiments; and

FIG. 7 illustrates a VDU configured in accordance with some embodiments.

### DETAILED DESCRIPTION

The following detailed description discloses various non-limiting example embodiments of the invention. The invention can be embodied in many different forms and is not to be construed as limited to the embodiments set forth herein.

Various embodiments of the present disclosure may arise from the present realization that providing a same fixed graphical user interface (GUI) to all passengers may satisfy some passengers, but will not sufficiently satisfy all passengers. A one-type-fits-all approach to GUI layout and operation is not an optimal approach for achieving passenger satisfaction. Some passengers have a high level of computer interface sophistication and are more likely to desire increased complexity GUIs that provide expanded capability and passenger-interaction efficient functionality. In sharp contrast, some other passengers have a lower level of computer interface sophistication (e.g., elderly with cognitive impairment, visual impairment, or young children) and are more likely to desire less complex more intuitive GUIs and/or should be provided less interface options for other reasons.

In accordance with various embodiments disclosed herein, an IFE system in a vehicle is provided that includes one or more GUI control processor(s) that allow one passenger (“companion passenger”) to interface through the VDU serving the companion's seat to generate commands that operate to configure operation of the GUI provided through another VDU serving another passenger (“assisted passenger”) to obtain services through the configured VDU. Non-limiting examples of relationships between companion and assisted passengers can include, but are not limited to, crew and passenger(s), adult child and elderly parent, parent and child, caregiver and mentally or visually disabled person, etc.

Although various embodiments are described herein in the context of IFE systems for aircraft, these and other embodiments are not limited thereto and may be used in other types of passenger vehicles, including without limitation, busses, trains, commuter rail, ships, etc.

Some further embodiments are directed to operations for selectively granting access privileges to the companion passenger to enable the companion passenger to configure the GUI provided to the assisted passenger. As will be explained in further detail below, configuration of the GUI may include, but is not limited to controlling what language is used, information layout in GUI layers, selectable widget layout in GUI layers, operational flow between GUI layers, operational flow between selectable widgets on a GUI layer, font size shape and/or color, application subset made available, on-demand content made available, timing and/or selection of advertisement types/format, selection (enabling/disabling) seat and/or lighting controls made available, controlling (enabling/disabling) crew request(s) made available for selection through the GUI, timing and selection of help items, etc.

In other words, various embodiments of the present disclosure are directed to an IFE system including a first VDU (“companion passenger's VDU”), a second VDU (“assisted passenger's VDU”), and a GUI control processor. The first VDU is assigned to a companion passenger, and the second VDU is assigned to an assisted passenger. The GUI control processor communicatively connected to the first VDU and the second VDU.

The first VDU includes a first GUI (“companion passenger's VDU GUI”) of the first VDU for display to the companion passenger. The second VDU includes a second GUI (“assisted passenger's VDU GUI”) of the second VDU for display to the assisted passenger.

The GUI control processor is configured to perform operations including receiving, from the first VDU, input from the companion passenger requesting configuration of the second GUI of the second VDU. The operations also include determining whether the companion passenger is granted access privileges to configure the second GUI of the second VDU. The operations also include, responsive to granting the access privileges, receiving configuration input from the companion passenger through the first VDU. The operations also include generating GUI configuration commands based on the configuration input, and transmitting the GUI configuration commands to the second VDU.

Additionally, the second VDU is configured to modify the second GUI of the second VDU based on the received GUI configuration commands.

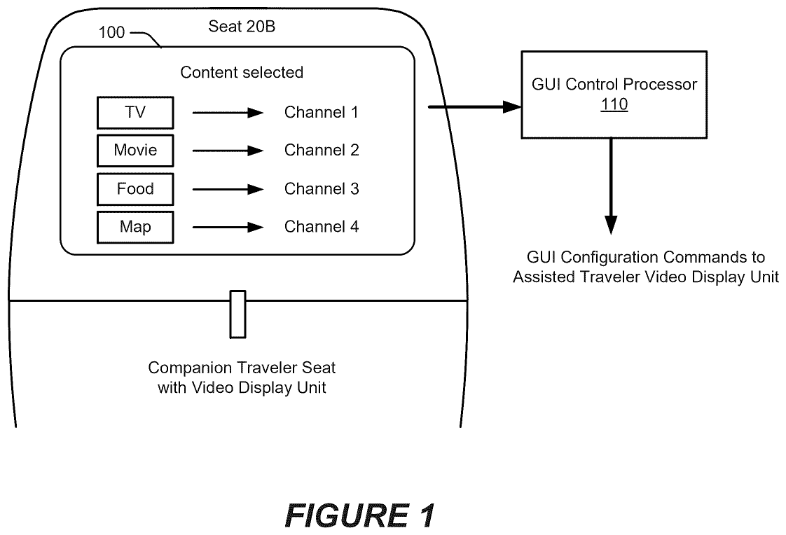

FIGS. 1-3 illustrate example GUIs of a VDU in a companion passenger seat which enable the companion passenger to configure the GUI provided to an assisted passenger through another VDU in the seat of the assisted passenger in accordance with some embodiments. In these examples, the companion passenger is seated in seat 20B while the assisted passenger is seated in seat 20A. In the figures, the seat number is illustrated on a back seat surface to indicate the seat number where the passenger is seated who is facing and being provided entertainment services by the VDU (indicates the seat number of the seat facing the back surface of the illustrated seat).

Referring to FIG. 1, the companion passenger interfaces with a GUI provided through a VDU 100 to selectively map what content that is available in four content categories (i.e., TV programs, movies, food related programs, and flight map travel information) are to be mapped to four different channels (Channels 1-4). The companion passenger's selections are provided to a GUI control processor 110 which responsively generates GUI configuration commands that are communicated to the VDU of an assisted passenger. As will be explained further below, other operations may have already been performed through which the companion passenger is determined to be granted access privileges that enable the companion passenger to use one VDU 100 to configure the GUI provided through another VDU 100 to the assisted passenger.

The GUI control processor 110 is illustrated as outside the VDU 100 for ease of discussion, but may be part of the VDU 100 or may be part of another IFE component, such as a content server, as will be explained further below.

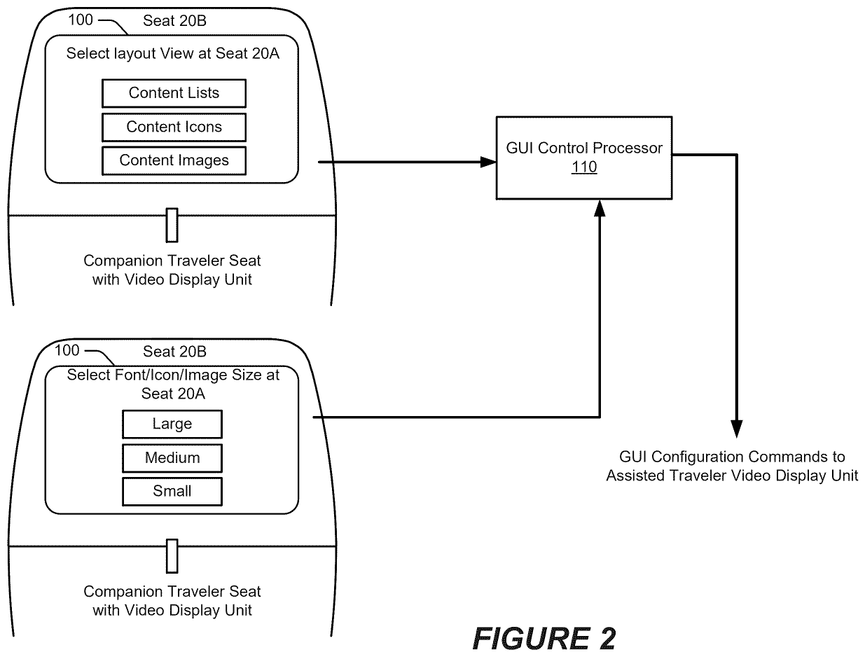

Referring to FIG. 2, two different GUI configuration layouts of the VDU 100 are illustrated in the upper and lower views of the companion seat 20B.

In the upper view, a set of user selectable widgets are displayed which the companion passenger may touch-select among to configure whether content is to be presented as lists of content descriptive text, as icons (e.g., representing content trademarks or other pictorial indications of the content), or as images (e.g., thumbnail images content such as screenshots of movies, TV programs, games, etc.) through the other VDU 100 of the assisted passenger's seat 20A. The companion passenger's selection is provided to the GUI control processor 110 which responsively generates GUI configuration command(s) that are provided to the other VDU 100 of the assisted passenger's seat 20A to configure its GUI operation.

In the lower view, another set of user selectable widgets are displayed which the companion passenger may touch-select among to configure the size of fonts, icons, and/or images that are provided through the other VDU 100 of the assisted passenger's seat 20A. The companion passenger's selection is provided to the GUI control processor 110 which responsively generates GUI configuration command(s) that are provided to the other VDU 100 of the assisted passenger's seat 20A to configure its GUI operation.

The companion passenger may be able to view a preview of possible modifications to the GUI viewed by the assisted passenger including the content items selectable and/or viewable to the assisted passenger. This allows the companion passenger to ensure the content items on the assisted passenger's GUI are in line with the goals of the companion passenger, such as appropriateness or accessibility of the content items and GUI. These content items may include at least one of an image, video, text, application, and widget.

In other words, in some embodiments, the first VDU is configured to display a preview of the second GUI modified based on the GUI configuration commands.

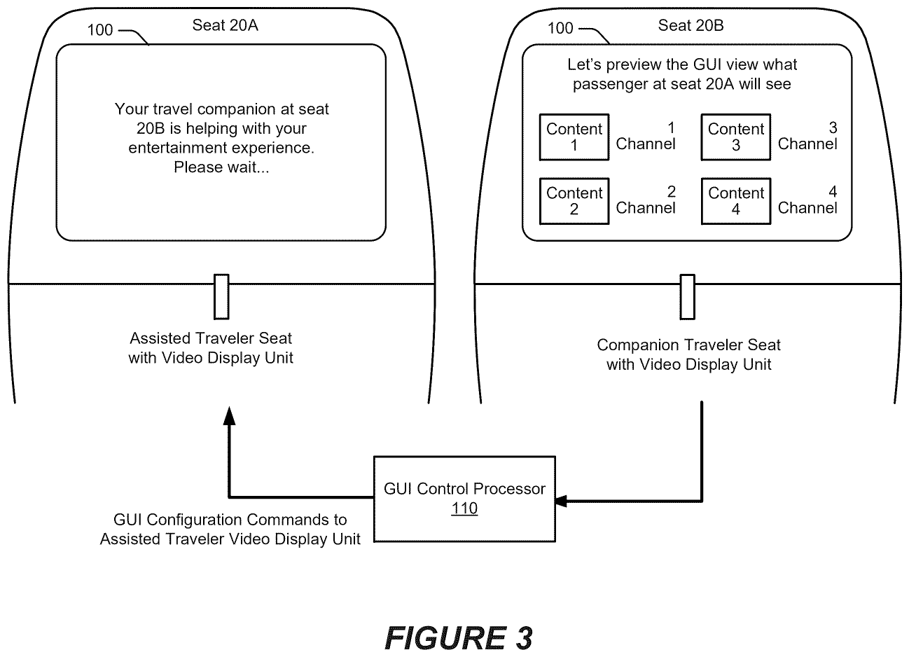

For example, referring to FIG. 3, on the right the companion passenger's VDU 100 serving seat 20B displays a preview of the GUI view that the assisted passenger at seat 20A will see through the other VDU 100 after configuration thereof by the GUI configuration commands generated by the GUI control processor 110. In the illustrated GUI view, the companion passenger has configured the assisted passenger's GUI to: map Content 1 to Channel 1, Content 2 to Channel 2, Content 3 to Channel 3, and Content 4 to Channel 4; and layout the content items in a 2×2 pattern with the illustrated font and image sizes.

While the companion passenger is configuring the assisted passenger's VDU 100 at seat 20A, the assisted passenger's VDU 100 may display a message explaining that a travel companion at seat 20B is helping with the assisted passenger's entertainment experience. The assisted passenger's VDU 100 interface may be locked or partially locked by the GUI control processor 110 (e.g., prevent or restrict content selections, etc. by the assisted passenger) while the companion passenger is performing the GUI configuration.

In other words, in some embodiments, the second VDU is configured to lock at least a defined part of the second GUI after the GUI control processor determines the companion passenger is granted access privileges to configure the second GUI of the second VDU until the second VDU modifies the second GUI of the second VDU based on the received GUI configuration commands.

These embodiments will prevent the assisted passenger from performing actions like accessing certain content items until the second GUI of the second VDU is configured by the companion passenger. An advantage of such locking of the second GUI include preventing the assisted passenger from accessing content items that may be determined to be inappropriate by the companion passenger for the assisted passenger to access. Another advantage includes the assistant passenger being prevented from using a GUI layout or GUI feature that does not include accessibility features the assisted passenger would benefit from but are not yet accessible on the second GUI.

Responsive to the companion passenger indicating acceptance of the previewed GUI view, e.g., by selecting an accept indication versus rejection indication, the selections are processed by the GUI control processor 110 to generate GUI configuration commands that are provided to the other VDU 100 to configure the GUI displayed to the assigned passenger at seat 20A. The assisted passenger's VDU 100 may be unlocked by the GUI control processor 110 (e.g., allow content selections, etc. by the assisted passenger) after implementing the GUI configuration commands.

The illustrated GUI control processor 110 may reside in the VDU of seat 20B, in the other VDU of seat 20A, in both VDUs, and/or in another component of the IFE system, e.g., a content server.

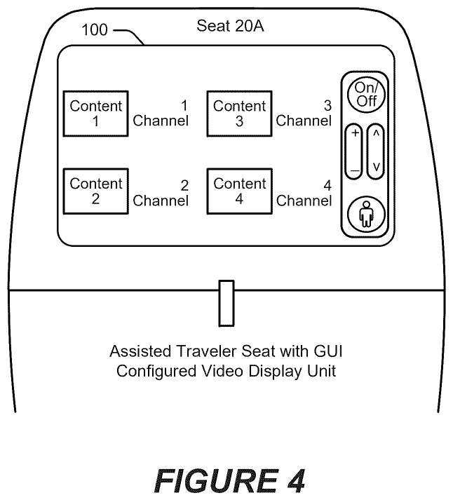

FIG. 4 illustrates the example GUI provided by the VDU 100 to the assisted passenger at seat 20A as a result of implementing the GUI configuration commands generated by the GUI control processor 110. In the illustrated GUI, the companion passenger has configured the assisted passenger's GUI to allow the assisted passenger to select among the content items selected by the companion passenger and to allow the assisted passenger to change audio volume and request assistance from a crew member.

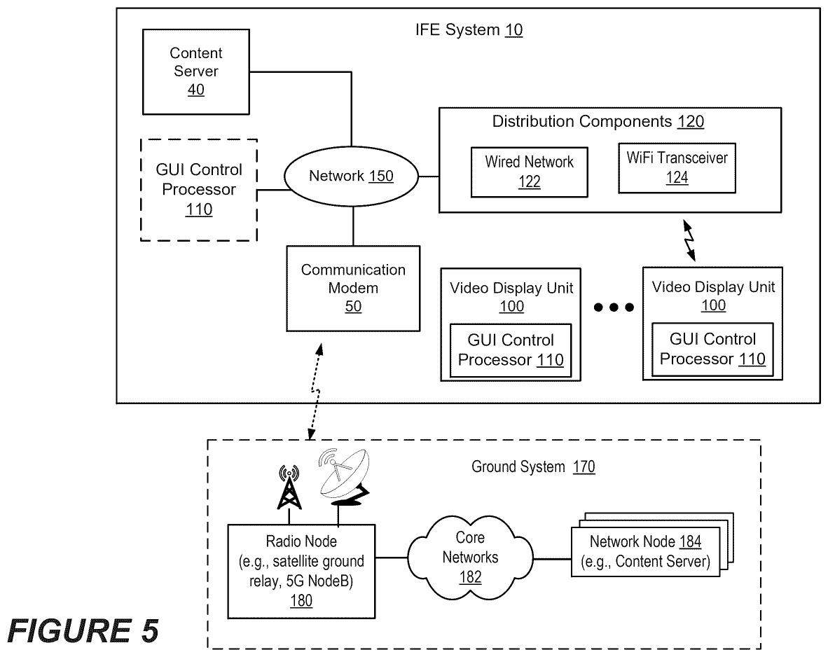

FIG. 5 illustrates a component block diagram of a ground system 170 and an aircraft IFE system 10 which are configured to operate in accordance with various embodiments of the present disclosure.

Although embodiments herein are primarily described in the context of in-flight entertainment solutions for an aircraft, the invention is not limited thereto. Instead, these and other related embodiments may be used with other types of vehicles, including, without limitation, ships (e.g., cruise ships), trains, subways, and buses. Accordingly, although various embodiments are described in the example context of involving passengers and crew, these and other embodiments may more generally be used by any persons (“users”). Accordingly, the terms passenger and user are used interchangeably without limitation.

Referring to FIG. 5, the IFE system 10 communicates with the ground system 170 using various communication technologies, e.g., proprietary satellite protocols, 3GPP 5G protocols, etc. More particularly, the example IFE system 10 includes a communication modem 50 that transmits and receives RF signaling through one or more antennas which is relayed by satellite(s) or transmitted directly to and from a ground-based radio node 180 (e.g., satellite gateway, 5G NodeB radio base station, etc.).

In the IFE system 10, content received by the communication modem 50 are transported via a network 140 to a content server 40 (also IFE controller) for possible distribution through the network(s) 150 and distribution components 120 (e.g., a wired network 122 and/or WiFi transceiver access points 124) to seat VDUs 100, crew terminals, and other avionics terminals. The VDUs 100 may each include the GUI control processor 110, which may additionally or alternatively be part of the content server 40 or part of another components of the IFE system 10.

The content server 40 may communicate with ground-based network nodes 184 (e.g., over-the-top servers providing content such as movies, TV programming, games, e-books, Internet webpages, etc.), through core networks 182 (e.g., private networks and/or public networks such as the Internet) and the radio node 180, etc. The content server 40 may provide content from the network nodes 184 to the VDUs 100 and may alternatively or additionally provide similar types of content that has been previously loaded into onboard memory.

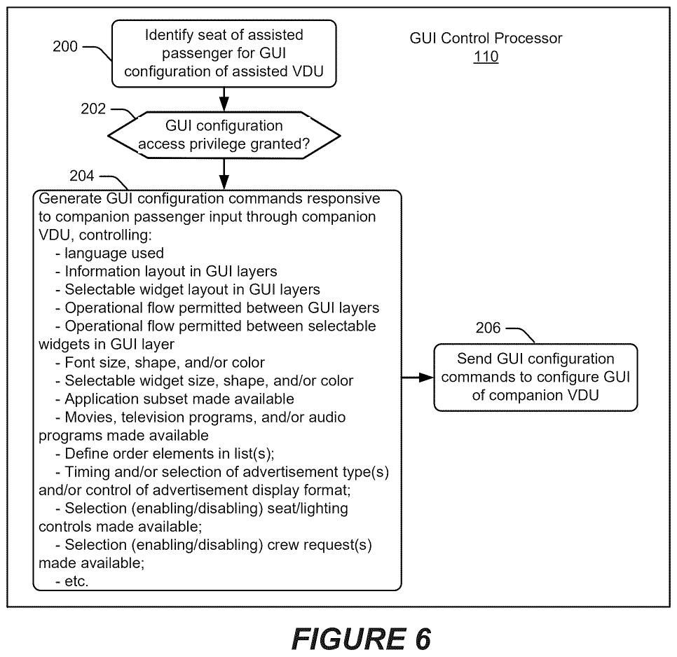

FIG. 6 illustrates operations and methods that may be performed at least in part by one or more of the GUI control processors 110.

In some scenarios the companion passenger and the assisted passenger are sitting in adjacent row seats, and it is therefore envisioned that the companion passenger may directly view and provide input directly to the VDU providing service to the assisted passenger to assist with operations to request GUI configuration, be granted access privileges that allow such GUI configuration, and perform operation to configure the GUI of the assisted passenger's VDU. In some other scenarios the companion passenger and the assisted passenger are sitting sufficiently spaced apart in the cabin (e.g., in different rows or in the same row but with intervening seats or aisle between them) such that it is envisioned that the companion passenger cannot directly view and operate the VDU providing service to the assisted passenger to provide input thereto that assists with GUI configuration.

Referring to FIG. 6, the operations identify 200 a seat of an assisted passenger who is to be provided with GUI configuration of their seat VDU. The operations may further identify the seat of the companion passenger who may be requesting or otherwise identified as wanting to configure the VDU providing service to the assisted passenger. The operations may determine 202 whether the companion passenger is to be granted GUI configuration access privileges to be able to configure the GUI of the VDU providing services to the assisted passenger.

In one example operation, the companion passenger may initiate the GUI configuration process by sending a request through the companion's VDU and/or through the assisted passenger's VDU to request configuration of the GUI of the VDU providing service to the assisted passenger.

In other words, in some embodiments, determining 202 whether the companion passenger is granted access privileges includes triggering display, on the second VDU, of a query message requesting permission from the assisted passenger. Then defining the companion passenger as being granted access privileges based on receiving an access granted message from the second VDU in response to the triggered display of the query message.

For example, the determination 202 operations, the assisted passenger is displayed a query message indicating that a named passenger seated at an identified seat number is requesting permission to configure the assisted passenger's VDU, and provided the ability to touch-select an indication of whether the request is to be granted or denied.

The request may include information identifying the companion passenger and/or the seat number of the companion passenger, and may include information identifying the assisted passenger and/or the seat number of the assisted passenger.

When the request identifies names of the companion passenger and/or assisted passenger, the GUI control processor 110 may access a passenger manifest or other information repository to lookup the seat number of the companion passenger and/or assisted passenger. The GUI control processor 110 may determine the network addresses of the VDUs serving the companion passenger and assisted passenger, and use the network addresses for routing messages to the respective VDUs.

The determination 202 of whether the companion passenger is to be granted access privileges to configure the GUI of the assisted passenger's VDU may be based on various information items that may be obtained from the companion passenger and/or assisted passenger, a passenger manifest, and/or other passenger information (e.g., passenger preferences for airline loyalty members) stored in a passenger information repository that is onboard or obtained from offboard the aircraft, e.g., a ground-based network node 184.

In other words, in some embodiments, determining 202 whether the companion passenger is granted access privileges includes determining if passenger manifest data indicates linked reservations or shared travel plans. The determination also includes defining the companion passenger as being granted access privileges based on the passenger manifest data indicating linked reservations or shared travel plans.

For example, the determination 202 operations may selectively grant the companion passenger the access privileges to configure the GUI of the assisted passenger's VDU based on whether information is stored in the passenger manifest stored onboard the aircraft and/or predefined passenger preferences stored onboard the aircraft which indicates that the companion passenger and the assisted passenger are traveling together, e.g., have linked reservations or travel plans.

In some embodiments, determining 202 whether the companion passenger is granted access privileges includes retrieving passenger information which indicates whether such GUI configuration permission has been determined. The determining 202 also includes defining the companion passenger as being granted access privileges based on the retrieving passenger information.

For example, the determination 202 operations may lookup passenger information that is stored in the passenger manifest and/or information that is stored in predefined passenger preferences which indicates whether such GUI configuration permission has been requested by the companion passenger and/or the assisted passenger, e.g., during booking of the flight and/or through the airlines website allowing loyalty members to define preferences to be used during the flight.

In some embodiments, determining 202 whether the companion passenger is granted access privileges includes comparing family names or home addresses of the companion passenger and the assisted passenger the determining 202 also includes defining the companion passenger as being granted access privileges based on the comparing determining the family names or home addresses of the companion passenger and the assisted passenger are the same.

For example, the determination 202 operations may selectively grant the companion passenger the access privileges based on whether the companion and assisted passenger's family name match in the passenger manifest and/or whether the companion and assisted passenger are determined (e.g., from the passenger manifest) to have the same home address.

Responsive to determining 202 that the companion passenger is granted access privileges to configure the GUI of the assisted passenger's VDU, the operations allow the companion passenger to provide input to configure the GUI and responsively generate 204 GUI configuration commands. The companion passenger may then control or adapt the GUI elements so that they are more optimized for use by the assisted passenger.

Configuration of the assisted passenger's GUI may include enabling and/or disability particular functionality or content that may be accessed by the assisted passenger.

The layout or style of information, functionality, and/or content items for display on the assisted passenger's VDU are defined by the configuration input received from the companion passenger though the companion passenger's VDU. The configuration input is used by the GUI control processor to generate the GUI configuration commands.

The configuration may include selecting what language among a set of available languages is to be used for the assisted passenger's VDU GUI.

The configuration may include selecting a layout of information for GUI layers from among a plurality of different defined layouts or companion passenger defined layouts of information for GUI layers displayable on the assisted passenger's VDU 100 based on the companion passenger's input through the companion passenger's VDU.

In other words, in some embodiments, the configuration input includes a selected one predefined layout of GUI layers from among a plurality of predefined layouts.

The layout of content items, such as selectable widgets, in GUI layers of the assisted passenger's VDU 100 may be controlled based on the companion passenger's input through the companion passenger's VDU. In one embodiment, the GUI control processor 110 selects a layout of selectable widgets for a GUI layer from among a plurality of different defined layouts of selectable widgets for a GUI layer displayable on the assisted passenger's VDU 100 based on the companion passenger's input.

In other words, in some embodiments, the configuration input includes a selected one predefined layout of selectable widgets from among a plurality of predefined widget layouts.

The operational flow between GUI layers of the VDU 100 may be controlled based on the companion passenger's input through the companion passenger's VDU. In one embodiment, the GUI control processor 110 selects an operational flow between passenger selectable widgets of different GUI layers from among a plurality of different defined operational flows between passenger selectable widgets of different GUI layers displayable on the assisted passenger's VDU 100 based on the companion passenger's input.

For example, the list of menus and/or operational features presented to the assisted passenger and/or content of menus presented for triggering operational flows may be simplified for the assisted passenger. The control may allow one assisted passenger to be provided more menu options for more advanced functionality and/or provided a greater array of operational features of the VDU 100, while another assisted passenger may be precluded from accessing such advanced functionality and/or provided a subset of the array of operational features.

In an illustrative embodiment, the configuration input includes a selection including whether content items are to be displayed as lists, icons, or images. In some embodiments, the configuration input includes selection of at least a font size, shape, or color. This allows content items to be displayed in the format most useful and accessible to the assisted passenger.

The configuration may include to determine a font size, shape, and/or color, and/or may include to determine a widget size, shape, and/or color to be displayed on the assisted passenger's VDU GUI based on the companion passenger's input. For example, one assisted passenger may be displayed text or selectable widgets having a greater minimum size and/or less graphically complex screen layouts than another assisted passenger.

The configuration may include to control what content is offered for consumption through the assisted passenger's VDU GUI based on the companion passenger's input.

In some embodiments, the configuration input includes selected content items to be made available to the assisted passenger.

In some embodiments, the configuration input includes filtering a list of movies, television programs, or audio programs based on metadata associated with the content.

For example, the GUI control processor 110 may filter a set of content stored on the content server 10 to generate a filtered list based on the companion passenger's input, which may include to identify the assisted passenger's age, disability, preferences, sensitivities, etc.

In an illustrative embodiment, the configuration input is configured to be a filtered subset of content items based on age, disability, preferences, or sensitivities of the assisted passenger.

In some embodiments, a subset of movies, television programs, and/or audio programs that are available on the content server 40, may be configured to be made available through the GUI of the VDU 100 operated by the assisted passenger. In one embodiment, the GUI control processor 110 generates a list of movies, television programs, and/or audio programs that are available from the memory within the content server 40 to be displayed through the GUI of the VDU 100 operated by the assisted passenger, and filters the list of movies, television programs, and/or audio programs based on the companion passenger's input to generate a filtered list of movies, television programs, and/or audio programs. The GUI control processor 110 then displays the filtered list of movies, television programs, and/or audio programs through the GUI of the VDU 100 operated by the assisted passenger. The filtering may furthermore be based on metadata that has been associated with the content. The metadata may include, but is not limited to, a description of the content, poster art representing the content, etc.

A subset of applications that are available on the content server 40, may be selected to be made available through the GUI of the VDU 100 for operation upon by a processor of the VDU 100 operated by the assisted passenger, based on the companion passenger's input. In one embodiment, the GUI control processor 110 generates a list of applications that are available from the memory within the content server 40 to be selectable through the GUI of the VDU 100 operated by the assisted passenger. The list of applications is filtered based on the companion passenger's input to generate a filtered list of applications, and the filtered list of applications is displayed through the GUI of the VDU 100 operated by the assisted passenger.

In some embodiments, the configuration input includes a selected subset of applications to be made available on the second VDU.

The configuration may include to filter the list of movies, television programs, audio programs, and/or applications to generate a recommended list based on the companion passenger's input, which may include to identify the assisted passenger's age, disability, preferences, sensitivities, etc.

The configuration may include to control an order with which content is identified in a list based on the companion passenger's input, which may include to identify the assisted passenger's age, disability, preferences, sensitivities, etc.

In other words, in some embodiments, the configuration input includes selecting an order in which content items are presented.

The configuration may include timing and/or selection of advertisement type(s) and/or control advertisement display format based on the companion passenger's input, which may include to identify the assisted passenger's age, disability characteristics, preferences, sensitivities, etc.

The events that trigger display of help items through the GUI of the VDU 100 operated by the assisted passenger may be configured based on the companion passenger's input. In one embodiment, the GUI control processor 110 selects a help item trigger event from among a plurality of different defined help item trigger events based on the companion passenger's input, and initiates display of a help item through the GUI of the VDU 100 operated by the assisted passenger, based on the help item trigger event that was selected becoming satisfied.

The content of the help items displayed through the GUI of the VDU 100 operated by the assisted passenger may be configured based on the companion passenger's input.

In some of these embodiments, the configuration input includes at least one selected help item trigger event selected from among a plurality of predefined trigger events.

The configuration may include to select (enable or disable) display of crew request widget(s), seat control widget(s), and/or seat lighting widget(s) on the GUI of the VDU 100 operated by the assisted passenger. For example, the companion passenger may configure the GUI of the assisted passenger's VDU 100 to not display to the assisted passenger a widget that would have allowed the assisted passenger to summon crew assistance (e.g., trigger an overhead crew request light or send a message to a crew terminal requesting help), to control seat recline mechanisms, to control seat lighting, etc. In another example, the companion passenger may configure the GUI of the assisted passenger's VDU 100 to disable the assisted passenger's ability to select a widget that, if selectable, would have allowed the assisted passenger to summon crew assistance, to control seat recline mechanisms, to control seat lighting, etc.

For some assisted passengers, it is not preferred for the assisted passenger to have access to a widget controlling their own seat or their ow seat lighting for various reasons. In such embodiments, the configuration input includes a selected at least one of a seat control widget and a seat lighting widget.

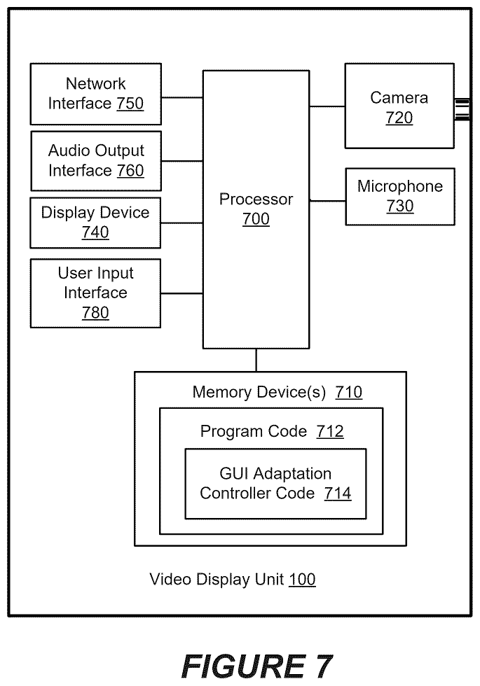

FIG. 7 is a block diagram of components that may be included in the VDU 100 configured to operate according to some embodiments. One or more of the components illustrated in FIG. 7 may be included in one or more elements of the system 10 other than the VDU 100, such as within the head end content server 40, a GUI control processor 110 that is separate from the VDU 100, or elsewhere.

The VDU 100 includes a processor 700 and a memory 710 containing program code 712. The processor 700 includes one or more data processing circuits, such as a general purpose and/or special purpose processor (e.g., microprocessor and/or digital signal processor). The processor 700 is configured to execute the program code 712 in the memory 710, described below as a computer readable medium, to perform some or all of the operations and methods that are described herein for one or more of the embodiments.

The program code 712 includes GUI adaptation controller code 714 that operates the processor 700 to perform according to one or more of the GUI controller processor 110 embodiments disclosed herein.

The VDU 100 may include a camera 720, a microphone 730, a display device 740, a network interface 750 (e.g., wired or RF wireless communication interface), an audio output interface 760, and a user input interface 780 (e.g., touch screen interface, switches, control wheels, buttons, keypad, keyboard, etc.). The camera 720 is positioned to generate a camera signal capturing the face of the companion passenger who is operating the VDU 110 to configured the GUI of the assisted passenger or capturing the face of the assisted passenger who's VDU will be configured. The camera 720 may be any type of sensor that may generate data representing observable characteristics of a passenger. The display device 740 is configured to display images to a passenger and display user selectable widgets (e.g., programmatic soft-buttons, etc.) that the companion passenger may select and manipulate (e.g., move) to configure the GUI of the assisted passenger's VDU.

The processor 700 may operate to process the camera signal using facial characterization and/or recognition algorithms and defined rules to determine whether GUI configuration access privileges are to be granted to the companion passenger for controlling the GUI of the assisted passenger's VDU. For example, the processor 700 may determine whether the companion passenger's face has matching characteristics defined for the companion passenger (e.g., obtained from an earlier photo of the companion passenger) and/or whether the assisted passenger's face has matching characteristics defined for the assisted passenger (e.g., obtained from an earlier photo of the assisted passenger).

The network interface 750 may connect through a RF transceiver to a passenger (e.g., mobile phone, smart watch, etc.) carried by the companion passenger and/or assisted passenger to receive data that may be used by the processor 700 to determine whether GUI configuration access privileges are to be granted to the companion passenger for controlling the GUI of the assisted passenger's VDU.

Further Embodiments and Definitions:

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another node, it can be directly connected, coupled, or responsive to the other element or intervening element may be present. In contrast, when an element is referred to as being “directly connected”, “directly coupled”, “directly responsive”, or variants thereof to another element, there are no intervening element present. Like numbers refer to like element throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate embodiments, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed:

1. An entertainment system for a passenger vehicle, comprising:
a first video display unit (VDU) assigned to a companion passenger;
a second VDU assigned to an assisted passenger; and
a graphical user interface (GUI) control processor communicatively connected to the first VDU and the second VDU,
wherein the first VDU comprises a first GUI of the first VDU for display to the companion passenger;
wherein the second VDU comprises a second GUI of the second VDU for display to the assisted passenger;
wherein the GUI control processor is configured to perform operations to:
receive, from the first VDU, input from the companion passenger requesting configuration of the second GUI of the second VDU,
determine whether the companion passenger is granted access privileges to configure the second GUI of the second VDU,
responsive to granting the access privileges, receive configuration input from the companion passenger through the first VDU,
generate GUI configuration commands based on the configuration input, and
transmit the GUI configuration commands to the second VDU; and
wherein the second VDU is configured to modify the second GUI of the second VDU based on the received GUI configuration commands.

2. The entertainment system, wherein determining whether the companion passenger is granted access privileges comprises:
triggering display, on the second VDU, of a query message requesting permission from the assisted passenger; and
defining the companion passenger as being granted access privileges based on receiving an access granted message from the second VDU in response to the triggered display of the query message.

3. The entertainment system of claim 1, wherein determining whether the companion passenger is granted access privileges comprises:
determining if passenger manifest data indicates linked reservations or shared travel plans; and
defining the companion passenger as being granted access privileges based on the passenger manifest data indicating linked reservations or shared travel plans.

4. The entertainment system of claim 1, wherein determining whether the companion passenger is granted access privileges comprises:
retrieving passenger information which indicates whether such GUI configuration permission has been determined; and
defining the companion passenger as being granted access privileges based on the retrieving passenger information.

5. The entertainment system of claim 1, wherein determining whether the companion passenger is granted access privileges comprises:
comparing family names or home addresses of the companion passenger and the assisted passenger; and
defining the companion passenger as being granted access privileges based on the comparing determining the family names or home addresses of the companion passenger and the assisted passenger are the same.

6. The entertainment system of claim 1, wherein the first VDU is configured to display a preview of the second GUI modified based on the GUI configuration commands.

7. The entertainment system of claim 1, wherein the second VDU is configured to lock at least a defined part of the second GUI after the GUI control processor determines the companion passenger is granted access privileges to configure the second GUI of the second VDU until the second VDU modifies the second GUI of the second VDU based on the received GUI configuration commands.

8. The entertainment system of claim 1, wherein the configuration input comprises a selected content items to be made available to the assisted passenger.

9. The entertainment system of claim 1, wherein the configuration input comprises a filtered a list of movies, television programs, or audio programs based on metadata associated with the content.

10. The entertainment system of claim 1, wherein the configuration input is configured to be a filtered subset of content items based on age, disability, preferences, or sensitivities of the assisted passenger.

11. The entertainment system of claim 1, wherein the configuration input comprises selecting an order in which content items are presented.

12. The entertainment system of claim 1, wherein the configuration input comprises a selected one predefined layout of GUI layers from among a plurality of predefined layouts.

13. The entertainment system of claim 1, wherein the configuration input comprises a selected one predefined layout of selectable widgets from among a plurality of predefined widget layouts.

14. The entertainment system of claim 1, wherein the configuration input comprises a selection comprising whether content items are to be displayed as lists, icons, or images.

15. The entertainment system of claim 1, wherein the configuration input comprises a selection of at least a font size, shape, or color.

16. The entertainment system of claim 1, wherein the configuration input comprises a selected subset of applications to be made available on the second VDU.

17. The entertainment system of claim 1, wherein the configuration input includes a selection of at least one of a seat control widget and a seat lighting widget.

18. The entertainment system of claim 1, wherein the configuration input comprises at least one selected help item trigger event selected from among a plurality of predefined trigger events.
